(19) United States
(12) Patent Application Publication
(10) Pub. No.: US 2004/0115603 A1
(43) Pub. Date: Jun. 17, 2004

(54) System and method for attention training

(76) Inventor: Robert F. Reynolds, (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/322,806

(22) Filed: Dec. 17, 2002

(51) Int. Cl. G09B 19/00

(52) U.S. Cl. 434/236; 434/219; 434/350

(57) ABSTRACT

A system and method for attention training includes a trainer unit used by a trainer and one or more trainee units, each vibrationally linked to a trainee. The trainer unit is used to send alert and reward signals, such as coded radio signals, to the trainee units, which consequently transmits alert and reward vibrations, respectively, to be felt by the trainee. In some implementations, the trainer observes the trainee behaving in an undesired manner, sends an alert signal via the trainer unit to the trainee unit to transmit an alert vibration to the trainee. If the trainee ceases behaving in the undesired manner, a reward signal is sent via the trainer unit to the trainee unit to generate a reward vibration to be felt by the trainee. Reward signals can be counted to track progress by the trainee.

### BACKGROUND OF THE INVENTION

1. Field of the Invention

The invention relates, in general, to signaling devices, and, in particular, to systems and methods for signaling devices for use in behavior modification.

2. Description of the Related Art

Conditions that detrimentally affect attention spans of individuals include attention deficit disorder (ADD), mental retardation, and brain injuries. Individuals with impaired attention spans or behavior can limit their potential advancement and disrupt group settings such as classrooms. Conventional devices have been found to improve attention spans of affected individuals, however, these devices have limited effectiveness. In a group setting, such as a classroom, the conventional devices tend to attract attention to the users, which can cause embarrassment and discourage use. The devices are also based upon approaches, which at times may put too much emphasis on undesirable behavior.

### BRIEF SUMMARY OF THE INVENTION

The present invention resides in a system and method for attention training. Embodiments include a trainer unit with a switch system having at least one switch portion and a transmitter configured to transmit, for each switch portion, first and second signals. A controller is so coupled to each of the switch portions of the switch system to identify occurrences of first and second conditions for each of the switch portions. The controller is so coupled to the transmitter to initiate transmission by the transmitter of the first signal for each switch portion when the controller identifies an occurrence of the first condition for the switch portion and to initiate transmission by the transmitter of the second signal for each switch portion when the controller identifies an occurrence of the second condition for the switch portion. A counter is so coupled to at least one of the switch system and the controller to generate a count of occurences of at least one of the first and second conditions of the switch portions; and an output so coupled to the counter to output the count of occurences of at least one of the first and second conditions of the switch portions.

Further embodiments include at least one trainee unit, each trainee unit associated with one of the switch portions of the trainer unit. Each of the trainee units include a receiver configured to receive the first and second signals of the switch portion of the trainer unit with which the trainee unit is associated, a vibrator configured to vibrate when electrically energized; and a controller so coupled to the receiver and to the vibrator to direct the vibrator to vibrate with a first vibration in response to the receiver receiving the first signal and to vibrate with a different second vibration in response to the receiver receiving the second signal.

Further embodiments include a method for training a trainee including observing the trainee behaving in an identifiable manner, upon observing the trainee behaving in the identifiable manner, sending a first signal to a trainee unit vibrationally linked to the trainee to produce a first vibration with the trainee unit to be felt by the trainee, observing the trainee substantially ceasing from behaving in the identifiable manner; and upon observing the trainee substantially ceasing from behaving in the identifiable manner, sending a second signal to a trainee unit vibrationally linked to the trainee to produce a second vibration with the trainee unit to be felt by the trainee, and incrementing a count to determine the number of second signals sent for a given period.

Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a schematic diagram illustrating an attention training system according to the present invention.

FIG. 2 is a flowchart of a method implemented by the attention training system shown in FIG. 1.

FIG. 3 is a schematic diagram illustrating a trainer unit of the attention training system shown in FIG. 1.

FIG. 4 is a schematic diagram illustrating a trainee unit of the attention training system shown in FIG. 1.

### DETAILED DESCRIPTION OF THE INVENTION

A system and method for attention training is described herein. The attention training system includes a trainer unit used by a trainer, such as a teacher, and a trainee unit used by a trainee, such as a student, who has an identified requirement for improvement in attention span. The trainer unit is used to send an alerting signal to the trainee unit to alert the trainee of undesired behavior. Upon improvement in behavior of the trainee, the trainer unit is then used to send a reward signal to the trainee unit to give the trainee a reward indication. The trainee unit furnishes alert and reward indications to the trainee in a discrete manner through use of vibrations, which diminishes the possibility of attention being focused on the trainee due to the use of the attention training system. The trainer unit tracks desirable responses of the trainee to alert indications so that tangible rewards can be appropriately administered to the trainee for improvement in the trainee's behavior. In some embodiments, the trainer unit is configured for operation with one trainee unit whereas in other embodiments the trainer unit is configured for operation with a plurality of trainee units.

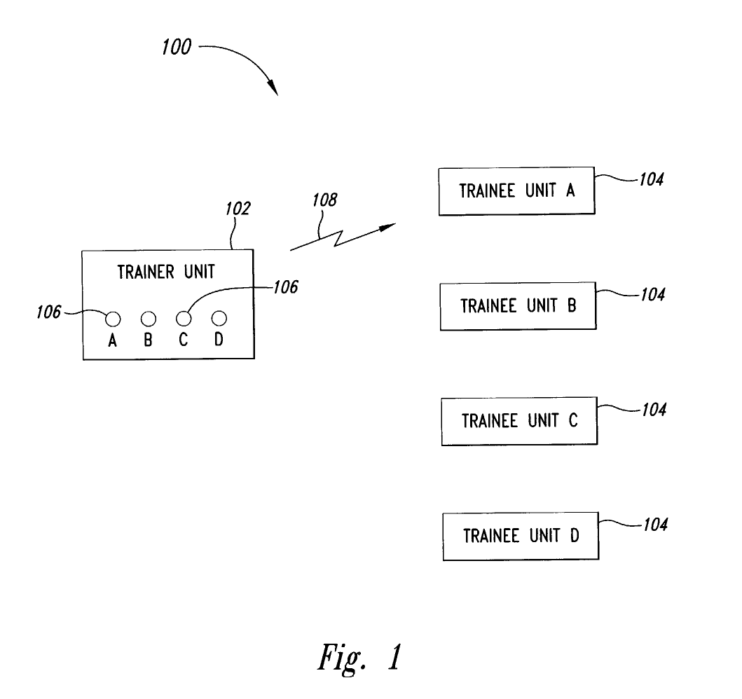

An attention training system 100, shown in FIG. 1, includes a trainer unit 102 used by a trainer and one or more trainee units 104 worn or carried by one or more trainees. Signaling interfaces 106 located in the trainer unit 102 include switches that are either opened or closed in a predefined manner to initiate transmission by the trainer unit of either alert or reward signals in the form of coded radio signals 108 to the trainee units 104. The signaling interfaces 106 use various input methods, such as pushbutton, toggle, or other switch mechanisms. In some implementations, each of the signaling interfaces 106 also contain outputs such as LCD displays of computer communication couplers to output status such as current count of alert and/or reward signals sent during a period of time. Typical embodiments of the trainer unit 102 use one signaling interface 106 for each of the trainee units 104 associated with the trainer unit, as shown in FIG. 1, to initiate transmission of the coded radio signals 108 as either alert or reward signals. Other embodiments of the trainer unit may use a pair of the signaling intefaces 106 for each of the trainee units 104 where one of the pair is used to initiate transmission of the alert signal and the other of the pair is used to initiate transmission of the reward signal. Other configurations of switches and outputs are used for the signaling interfaces 106 in other embodiments of the invention.

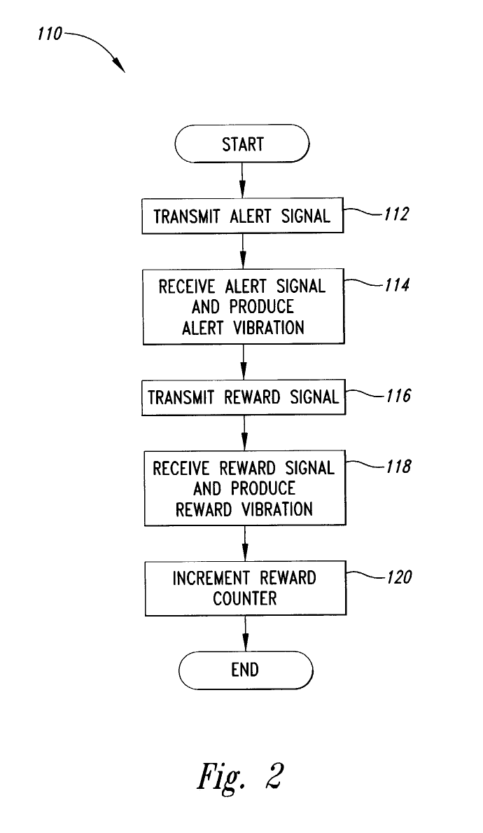

A method 110, shown in FIG. 2, implemented through use of the attention training system 100 starts by transmitting one of the alert signals from the trainer unit 102 to one of the trainee units 104 (step 112), worn or carried by the trainee, upon observation by the trainer that the trainee is experiencing a diversion of his attention from a desired focus, such as a lesson being taught by the trainer. The trainee unit 104 of that trainee and only that trainee receives the alert signal and produces an alert vibration (step 114) that is felt by the trainee whose attention was diverted.

Upon observation by the trainer that the trainee has refocused his attention onto the desired focus in response to the alert vibration, the trainer unit 102 is then used to transmit one of the reward signals to the trainee unit 104 of that trainee and only that trainee (step 116). The trainee unit 104 receives the reward signal and produces a reward vibration (step 118) that is felt by the trainee. The trainer unit 102 also keeps track of the number of reward signals transmitted to the particular trainee unit 104 by incrementing a reward counter (discussed further below) (step 120) to be output by the trainer unit as status information for the trainer, after which the method 110 ends. This outputted status information can be used among other things as criteria for providing tangible rewards to the trainee either immediately or at a later time.

Other embodiments may increment the reward counter at a different time relative to the other steps of the method 110 or may have other parameters used for tracking alert signals and reward signals. For instance, totals for the number of alert signals and reward signals transmitted could be counted and outputted so that the trainee can be later rewarded based upon a mathematical combination of both total alert signals and total reward signals rather than just total reward signals. Other configurations may solely track total number of alert signals transmitted so that the trainee is later rewarded based upon how few alert signals were transmitted. For instance, a tangible reward given to the trainee could be based upon total number of alerts subtracted from an initial base amount.

An advantage of using alert and reward vibrations is that the trainee can receive the vibrations discreetly without others present realizing that the alert and reward signals have been sent. In certain circumstances, such as a classroom, this can minimize embarrassment or discouragement typically caused by conventional systems in how they signal intended recipients. In addition, it allows the trainer to continue the trainer's instruction without interrupting other trainees. Alert vibrations are distinguished from reward vibrations by such factors as vibration intensity, number of vibration periods for each alert and reward vibration, duration of each vibration period, and interval frequency of vibration periods. For instance, in some implementations the alert vibration is a series of short duration vibration pulses whereas the reward vibration is one long duration vibration period. The vibration intensity used for the alert vibration and the reward vibration may be comparatively similar and of relatively low intensity to conserve battery life in portable applications. Where battery life is not a concern, the alert vibration and the reward vibration can be further distinguished through use of different vibration intensity levels.

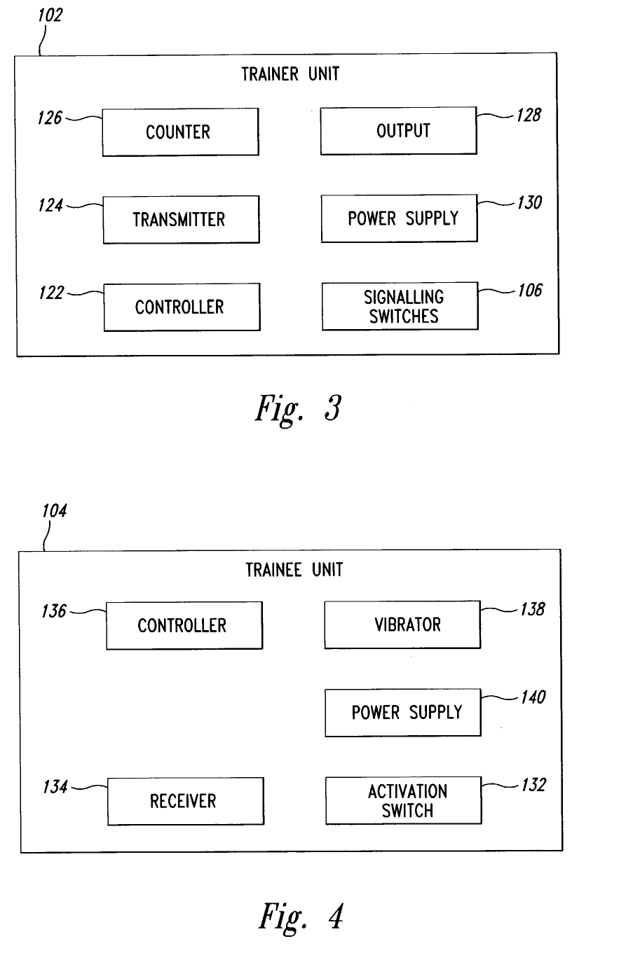

The trainer unit 102 shown in FIG. 3 includes the one or more signaling interfaces 106, a controller 122, a transmitter 124, a counter 126, an output 128, and a power supply 130. In some implementations the controller 122 is programmed to distinguish how long the switch of one of the signaling interfaces 106 is opened or closed. For instance, the controller 122 in one implementation recognizes for a pushbutton type of switch for the signaling interface 106 that of a depression of the switch for a short period of time (e.g. less than a second) followed by a release of the switch would indicate that an alert signal should be sent by the trainer unit 102, whereas depression of the switch for a long period of time (e.g. more than two seconds) would indicate that the reward signal should be sent by the trainer unit.

The controller 122 directs the transmitter 124 to transmit either an alert signal or a reward signal based upon the trainer's desire as indicated by the signaling interface 106. In some implementations, the transmitter 124 uses conventional radio technology to send digitally coded signals to the trainee unit 104 using appropriately chosen frequency spectrum portions according to governmental agency approved frequency allocation plans.

A counter 126, either incorporated into the controller 122 or as a separate component is used in some implementations to track either the number of alert signals sent, the number of reward signals sent or both the number of alert signals and reward signals sent to each of the trainee units 104 designated to receive communication from the trainer unit 102. Current count information from the counter 126 is outputted on the output 128. A reset button (not shown) can be used to reset counts being accumulated for each of the trainee units 104 and to zero the counts shown on the output 128. In some implementations the output 128 is a display of a continuous LCD type having a low current requirement to assist in lengthening life of batteries, which are typically used as the power supply 130. In other implementations, the output 128 is a data interface for transferring data to a network, computer, peripheral device, such as a printer, monitor, storage device, or other electronic data device.

The power supply 130 of different implementations varies. For instance, in some implementations a 9 volt power supply is used which allows for greater flexibility and design. Other implementations use AA batteries in conjunction with a step-up regulator since AA batteries tend to provide more economical operation. In other implementations various other power supplies are contemplated, however, long battery life, such as three to six months of normal operation, is typically desirable. Trade-offs between long battery life versus size and weight of the trainer unit 102 are also involved. Since the trainer unit 102 need not be worn by the trainer and can be somewhat conspicuous, long battery life is emphasized over size and weight issues in some implementations.

The trainee unit 104 shown in FIG. 4 includes an activation switch 132, a receiver 134, a controller 136, a vibrator 138, and a power supply 140. The activation switch 132 is used to turn the trainee unit 104 on and off. In some implementations, to increase ease-of-use, the activation switch 132 uses a vibration sensor or motion sensor of conventional design that is configured to close for typically a short duration of time when the activation switch is subject to a certain level vibration, acceleration, or other such motion such as resulting from the trainee unit 104 being moved. If the trainee unit 104 is off when the activation switch 132 closes, the controller 136 turns on the trainee unit 104. Furthermore, if the trainee unit 104 is on when the activation switch 132 closes due to further movement of the trainee unit, the controller 136 interprets the additional closing to mean that the trainee unit should remain activated and does not turn off the trainee unit. If the trainee unit 104 does not experience movement for a certain predetermined amount of time, the activation switch 132 consequently does not close for the certain predetermined amount of time and the controller 136 interprets this to mean that the trainee unit should be turned off and turns off the trainee unit. The implementations of the trainee unit 104 that incorporate a vibration style switch for the activation switch 132 in conjunction with the controller 136 as described tend to experience longer battery life since the trainee units have essentially an automatic shutoff mechanism to help prevent the trainee units from inadvertently being left on when not in use. The vibration style activation switch 132 also allows for automatic activation of the trainee unit 104 which helps to increase compliance of its use by the trainees.

An activation switch for the trainer unit 102 could be similarly configured as the above-described activation switch 132 of the trainee unit 104. Activation switches in other implementations of the trainer unit 102 could couple the signaling interfaces 106 to the controller 136 such that lack of use of the signaling interfaces over a prolonged predetermined length of time would indicate to the controller 136 to turn the trainer unit 102 off, or alternatively, transmit a signal, such as an audio signal, to the trainer alerting him of the prolonged inactivity before automatically shutting off the trainer unit.

The receiver 134 in some implementations of the trainee unit 104 uses a communications code chip typically with thousands of codes, such as 64,000 codes to decode signals received from the trainer unit 102. The receiver 134 includes an antenna, which can comprise a portion of the body of the trainee and/or small antenna coils such as those found on conventional printed circuit cards. The trainee unit 104 typically uses an antenna that is not externally visible. The receiver 134 in some implementations uses high frequency standard radio technology that optionally may use handshaking to establish communication between the trainee unit 104 and the trainer unit 102. The handshaking adds additional expense to the overall attention training system 100 so is left out in some implementations where any additional reliability gain through use of handshaking is outweighed by the additional expense involved.

Based upon whether an alert signal or a reward signal is received by the trainee unit 104, the controller 136 directs the vibrator 138 to produce a predetermined pattern of vibrations to indicate either an alert or reward, accordingly, to the trainee. The vibrator 138 is selected to produce vibrations that are sufficiently noticeable by the trainee yet not too intense so that battery life of the power supply 140 is prolonged. The trade-offs involved with power supply selection include battery life and size of the trainee unit 104. In some implementations, two AAA batteries are used as a compromise between battery life and trainee unit size. Implementations include inconspicuous positioning of the trainee unit 104 around the wrist or neck or in a clothing pocket of the trainee, so size of the trainee unit can have a significant impact regarding these implementations.

At the completion of one or more training sessions, data regarding the number of reward signals, alert signals, or both for each trainee are reviewed by the trainer. In some implementations the trainee is rewarded based upon how many reward signals are sent to the particular trainee unit. Under these implementations it is felt that attention training is facilitated through encouragement by receipt of reward vibrations by the trainee at the moment the trainee corrects their behavior and subsequent receipt of tangible rewards based upon the number of reward signals sent to the trainee unit 104 worn by the trainee. Other implementations base use of the attention training system 100 on a premise that the trainee will maintain correct behavior while under a continual threat that one or more promised rewards will be lost. Under this threat style implementation, tangible rewards can be given to the trainee based upon the number of alert signals sent to the trainee unit 104 of the trainee wherein fewer alert signals results in greater tangible rewards. Other implementations use a weighted combination of both the number of reward signals and the number of alert signals sent to the trainee unit 104 of the trainee.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., size, weight, speed, flexibility, or predictability) of the implementer, any of which may vary.

In a general sense, those skilled in the art will recognize that the various embodiments described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

I claim:

1. An attention training system comprising:
a trainer unit including:
a switch system including switch portions;
a transmitter configured to transmit, for each switch portion, first and second signals;
a controller so coupled to each of the switch portions of the switch system to identify occurrences of first and second conditions for each of the switch portions, the controller so coupled to the transmitter to initiate transmission by the transmitter of the first signal for each switch portion when the controller identifies an occurrence of the first condition for the switch portion and to initiate transmission by the transmitter of the second signal for each switch portion when the controller identifies an occurrence of the second condition for the switch portion;
a counter so coupled to at least one of the switch system and the controller to generate a count of occurences of at least one of the first and second conditions of the switch portions; and
an output so coupled to the counter to output the count of occurences of at least one of the first and second conditions of the switch portions; and
a plurality of trainee units, each associated with one of the switch portions of the trainer unit, each of the trainee units including:
a receiver configured to receive the first and second signals of the switch portion of the trainer unit with which the trainee unit is associated;
a vibrator configured to vibrate when electrically energized; and
a controller so coupled to the receiver and to the vibrator to direct the vibrator to vibrate with a first vibration in response to the receiver receiving the first signal and to vibrate with a different second vibration in response to the receiver receiving the second signal.

2. The system of claim 1 wherein the transmitter of the trainer unit transmits coded radio signals and the receiver of the trainee unit receive coded radio signals.

3. The system of claim 1 wherein the vibrator vibrates for the first vibration with a series of vibration periods, each vibration period less than one second, and vibrates for the second vibration with a vibration period exceeding two seconds.

4. The system of claim 1 wherein the output is an LCD display.

5. The system of claim 1 wherein the output is a data interface.

6. The system of claim 1 wherein each of the switch portions of the switch system is a switch, and an occurrence of the first condition for the switch portion includes the switch being in a closed position for less than one second, and an occurrence of the second condition for the switch portion includes the switch being in a closed position for more than two seconds.

7. The system of claim 1 wherein each of the switch portions of the switch system includes a first switch and a second switch, and an occurrence of the first condition for the switch portion includes the first switch being closed and the second switch being open, and an occurrence of the second condition for the switch portion includes the first switch being open and the second switch being closed.

8. The system of claim 1 wherein the counter and the controller are integrated together into a single processor.

9. An attention training system comprising:
a trainer unit including:
a switch having first and second conditions;
a transmitter configured to transmit first and second signals;
a controller so coupled to the switch to identify occurrences of the first and second switch conditions, the controller so coupled to the transmitter to initiate transmission by the transmitter of the first signal when the controller identifies an occurrence of the first switch condition and to initiate transmission by the transmitter of the second signal when the controller identifies an occurrence of the second switch condition;
a counter coupled to generate a count of occurences of at least one of the first and second switch conditions; and
an output so coupled to the counter to output the count of occurences; and
a trainee unit configured to vibrationally contact a trainee, the trainee unit including:
a receiver configured to receive the first and second signals;
a vibrator configured to vibrate when electrically energized; and
a controller so coupled to the receiver and to the vibrator to direct the vibrator to vibrate with a first vibration in response to the receiver receiving the first signal and to vibrate with a different second vibration in response to the receiver receiving the second signal.

10. An attention training system comprising:
a trainer unit including:
a switch having first and second conditions;
a transmitter configured to transmit first and second signals;
a controller so coupled to the switch to identify occurrences of the first and second switch conditions, the controller so coupled to the transmitter to initiate transmission by the transmitter of the first signal when the controller identifies an occurrence of the first switch condition and to initiate transmission by the transmitter of the second signal when the controller identifies an occurrence of the second switch condition; and
a trainee unit including:
a receiver configured to receive the first and second signals;
a vibrator configured to vibrate when electrically energized; and
a controller so coupled to the receiver and to the vibrator to direct the vibrator to vibrate with a first vibration in response to the receiver receiving the first signal and to vibrate with a different second vibration in response to the receiver receiving the second signal.

11. An attention training system comprising:
a trainer unit including:
a switch having first and second conditions;
a transmitter configured to transmit first and second signals;
a controller so coupled to the switch to identify occurrences of the first and second switch conditions, the controller so coupled to the transmitter to initiate transmission by the transmitter of the first signal when the controller identifies an occurrence of the first switch condition and to initiate transmission by the transmitter of the second signal when the controller identifies an occurrence of the second switch condition;
a counter coupled to generate a count of occurences of at least one of the first and second conditions of the switch; and
an output so coupled to the counter to output the count of occurences; and
a trainee unit including:
a receiver configured to receive the first and second signals;
a vibrator configured to vibrate when electrically energized;
an activation switch so configured and positioned to change from a first state to a second state when the trainee unit moves and to change from the second state to the first state when the trainee unit becomes substantially motionless; and
a controller so coupled to the receiver and to the vibrator to direct the vibrator to vibrate with a first vibration in response to the receiver receiving the first signal and to vibrate with a different second vibration in response to the receiver receiving the second signal, the controller so coupled to the motion sensor to activate the receiver when the motion sensor changes from the first state to the second state and to deactivate the receiver a predetermined amount of time after the motion sensor changes from the second state to the first state.

12. A method for training a trainee comprising:
observing the trainee behaving in an identifiable manner;
upon observing the trainee behaving in the identifiable manner, sending a first signal to a trainee unit vibrationally linked to the trainee to produce a first vibration with the trainee unit to be felt by the trainee;
observing the trainee substantially ceasing from behaving in the identifiable manner; and
upon observing the trainee substantially ceasing from behaving in the identifiable manner, sending a second signal to the trainee unit vibrationally linked to the trainee to produce a different second vibration with the trainee unit to be felt by the trainee.

13. A method for training a trainee comprising:
observing the trainee behaving in an identifiable manner;
upon observing the trainee behaving in the identifiable manner, sending a first signal to a trainee unit vibrationally linked to the trainee to produce a first vibration with the trainee unit to be felt by the trainee;
observing the trainee substantially ceasing from behaving in the identifiable manner; and
upon observing the trainee substantially ceasing from behaving in the identifiable manner, sending a second signal to a trainee unit vibrationally linked to the trainee to produce a second vibration with the trainee unit to be felt by the trainee; and
incrementing a count to determine the number of second signals sent for a given period.

14. A method for training a trainee comprising:
observing the trainee behaving in an identifiable manner;
upon observing the trainee behaving in the identifiable manner, sending a first signal to a trainee unit vibrationally linked to the trainee to produce a first vibration with the trainee unit to be felt by the trainee; and
decrementing a count from an initial number for each first signal sent.

15. A method for training a first trainee and a second trainee comprising:
observing the first trainee behaving in a first identifiable manner;
upon observing the first trainee behaving in the first identifiable manner, sending a first alert signal to a first trainee unit vibrationally linked to the first trainee to produce an alert vibration with the first trainee unit to be felt by the first trainee;
observing the first trainee substantially ceasing from behaving in the first identifiable manner;
upon observing the first trainee substantially ceasing from behaving in the first identifiable manner, sending a first reward signal to the first trainee unit vibrationally linked to the first trainee to produce a reward vibration with the first trainee unit to be felt by the first trainee;
observing the second trainee behaving in at least one of following: the first identifiable manner and a second identifiable manner;
upon observing the second trainee behaving in at least one of following: the first identifiable manner and the second identifiable manner, sending a second alert signal to a second trainee unit vibrationally linked to the second trainee to produce an alert vibration with the second trainee unit to be felt by the second trainee;
observing the second trainee substantially ceasing from behaving in at least one of following: the first identifiable manner and the second identifiable manner; and
upon observing the second trainee substantially ceasing from behaving in at least one of following: the first identifiable manner and second identifiable manner, sending a second reward signal to the second trainee unit vibrationally linked to the second trainee to produce a reward vibration with the second trainee unit to be felt by the second trainee.
